(19) United States
(12) Patent Application Publication
(10) Pub. No.: US 2026/0108828 A1
(43) Pub. Date: Apr. 23, 2026

(54) A DISTRIBUTOR FOR A DEVOLATILIZATION APPARATUS COMPRISING A HOLLOW DOUBLE-PLATE ASSEMBLY

(71) Applicant: SULZER MANAGEMENT AG, Winterthur (CH)

(72) Inventors: Yingchuan YU, Winterthur (CH); Sen ZHANG, Singapore (SG); Hui Feng ZHU, Shanghai (CN); Chin Chyau LEW, Singapore (SG); Rong Gang GUO, Shanghai (CN); Zhe LI, Shanghai (CN)

(21) Appl. No.: 19/144,949

(22) PCT Filed: Dec. 11, 2023
(86) PCT No.: PCT/CN2023/137862

§ 371 Date: Jun. 30, 2025

(30) Foreign Application Priority Data
Jan. 12, 2023 (WO) PCT/CN2023/000006
Mar. 14, 2023 (EP) 23161892.7

(51) Int. Cl. B01D 19/00

(52) U.S. Cl. CPC B01D 19/0036; B01D 19/0068

(57) ABSTRACT

A heatable distributor includes a vessel with an upstream portion and an adjacent downstream portion, the upstream portion includes a first lateral end with an inlet and a second lateral end connected with the downstream portion. the downstream portion includes a first lateral end and a second lateral end, the first lateral end connected with the second lateral end of the upstream portion, and the downstream portion includes a hollow double-plate assembly including an upper plate and a lower plate spaced apart so that a void chamber is defined therebetween. Each plate includes openings, each opening of the upper plate is surrounded by a wall extending through the void chamber and surrounding an opening of the lower plate to form channels being fluid-tightly separated from the hollow space and, the hollow space is connected with an inlet for a heat medium and with an outlet for the heat medium.

### CROSS REFERENCE TO RELATED APPLICATIONS

This application is a U.S. national stage application of International Application No. PCT/CN2023/137862, filed on Dec. 11, 2023 which claims priority to European Patent Application No. 23161892.7 which was filed on Mar. 14, 2023, International Application No. PCT/CN2023/000006, filed on Jan. 12, 2023 the contents of each of which are hereby incorporated by reference.

### TECHNICAL FIELD

The present disclosure relates to a distributor for a devolatilization apparatus as well as to a devolatilization apparatus for devolatilizing a composition comprising a volatile component, such as for devolatilizing a solid or liquid polymer composition comprising non-reacted monomer and solvent. Furthermore, the present disclosure relates to a devolatilization process making use of such a devolatilization apparatus.

### BACKGROUND

Devolatilization or degassing, respectively, denotes the controlled removal of gases and of other volatile substances, such as solvents or moisture, from solids and liquids. Devolatilization is commonly used to remove volatile components, which are mostly components having a comparable low molecular weight, such as residual monomers, solvents, reaction by-products and water, from polymers. This is necessary, in order to achieve a required purity of the respective polymer before its use by removing harmful and/or toxic components, by removing components negatively affecting the further processing of the polymer, such as its formability to articles, by removing components worsening the properties of the polymer, by removing components leading to an unpleasant smell of the polymer and/or by removing components being undesired for other reasons. Furthermore, the removal of monomers and solvent from a polymer composition allows to recover and potentially recycling of the monomers and solvent in the process so as to increase the yield of the process as well as to reduce the quantity of waste.

In order to achieve a devolatilization, the component to be evaporated needs to have a higher partial pressure or higher thermodynamic activity, respectively, than the polymer. Moreover, the component to be evaporated needs to be able to diffuse through the polymer composition to the phase boundary. In particular in the case of viscous polymers or polymer melts-and typically polymers and polymer melts are comparable viscous-the slow diffusion rate can be a speed limiting factor. Therefore, in order to accelerate the devolatilization, the composition being subjected to the devolatilization is usually devolatilized at an elevated temperature and/or devolatilized at a subatmospheric pressure, because both measurements increase the thermodynamic activity of the volatile component(s) and an increase of the temperature moreover decreases the viscosity of the polymer, thus improving the diffusion of the volatile component(s) within the polymer. However, most of the polymers are-more or less-heat sensitive so that a certain temperature, which is characteristic for each polymer, shall not be exceeded, in order to reliably avoid a polymer degradation during the devolatilization. Thus, temperature control of the composition to be devolatilized during the devolatilization is an important and in fact decisive factor.

Several types of devolatilization apparatuses are known, such as static and dynamic devolatilization apparatuses. While a dynamic devolatilization apparatus comprises moving parts, such as blades, in order to maintain a high interfacial concentration gradient and in order to maintain a high diffusion rate of the volatile component(s) within the polymer, a static devolatilization apparatus does not comprise moving parts, but comprises internals so as to create a high specific surface of the composition to be devolatilized. However, dynamic devolatilization apparatuses are, on account of their moving parts, connected with drastic disadvantages, such as being costly, requiring during the operation a high amount of energy, requiring regular maintenance and having a comparable high leak rate.

Thus, static devolatilization apparatuses have in comparison to dynamic devolatilization apparatuses the advantages-due to the absence of moving parts-of less energy consumption, of less installation costs, of requiring less maintenance and of having a comparable low leak rate. Common types of static devolatilization apparatuses are flash devolatilization apparatuses and falling strand devolatilization apparatuses. Flash devolatilization apparatuses typically comprise a preheater, for example a heat exchanger, and a flash chamber. During the operation, the polymer composition to be devolatilized is firstly pumped to the heat exchanger, where it is heated up and optionally pressurized in order to decrease its viscosity, before it is then pumped from the heat exchanger into the top of the flash chamber, where the pressure is relieved and evaporation of the volatile component(s) occurs. Thereafter, the polymer composition falls downwardly through the flash chamber, during which a plurality of bubbles of the volatile component(s) is nucleated in the polymer composition. This results in a large amount of surface area for mass transfer and thus leads to a fast devolatilization. While the volatilized vapor phase is collected and condensed in a condenser, the residual polymer composition collects at the bottom of the flash chamber and is removed via pumping. Falling strand devolatilization apparatuses operate similarly to flash devolatilization apparatuses, but have specially embodied nozzles in order to inject the polymer composition into the chamber as falling strands, in order to promote the growth of bubbles of the volatile component(s) and in order to accelerate the diffusion process.

### SUMMARY

In order to utilize the devolatilization apparatus efficiently, often a distributor is arranged in the top portion of the devolatilization apparatus in order to adjust the temperature of the composition to be devolatilized directly after the inlet and to distribute the composition to be devolatilized over the cross-sectional area of the devolatilization apparatus. As indicated above, the temperature control of the composition to be devolatilized during the devolatilization and thus in particular in the distributor is an important and in fact decisive factor. This is all the more important in cases, in which temperature sensitive compositions, such as temperature sensitive polymer compositions, are to be devolatilized. A non-optimal temperature control of the composition to be devolatilized during the devolatilization leads to non-optimal devolatilization results. For example, a lower operational temperature than the optimal operational temperature during the devolatilization results in that comparable low amounts of the volatile component(s) contained in the polymer composition are separated from the polymer, in that the devolatilized polymer product being discharged from devolatilization apparatus at a lower than the optimal designed temperature can cause in downstream equipment an abnormal operation and/or in that the intended property of the devolatilized polymer product is not achieved after the devolatilization process.

In view of this, the object underlying the present disclosure is to provide a distributor for a devolatilization apparatus for devolatilizing a composition comprising a volatile component, such as for devolatilizing a solid or liquid polymer composition comprising non-reacted monomer, solvent and/or by-product, which allows to reliably adjust the temperature of the composition to be devolatilized to the devolatilization operating temperature required during the operation of the devolatilization apparatus, so as to allow that the devolatilization apparatus including the distributor achieves an optimal devolatilization of the composition to be devolatilized at low operational costs, wherein the distributor is characterized by low capital expenditures, so that a devolatilized composition with an optimal product quality is obtained even in a case that the composition to be devolatilized is a polymer composition comprising a particular temperature sensitive polymer.

In accordance with the present disclosure, this object is satisfied by providing a heatable distributor, in particular for a devolatilization apparatus for devolatilizing a composition comprising a volatile component, such as for devolatilizing a solid or liquid polymer composition comprising non-reacted monomer, solvent and/or by-product, wherein the heatable distributor comprises at least one vessel with an upstream portion and an adjacent downstream portion, wherein the upstream portion of the vessel comprises a first lateral end comprising an inlet and an opposite second lateral end being connected with the downstream portion, wherein the downstream portion of the vessel comprises a first lateral end and an opposite second lateral end with the first lateral end being connected with the second lateral end of the upstream portion, and wherein the downstream portion of the vessel comprises a hollow double-plate assembly, wherein the hollow double-plate assembly comprises an upper plate and a lower plate being arranged on top of each other, but spaced apart so that a void chamber is defined therebetween, wherein each of both plates comprises a plurality of openings, wherein each opening of the upper plate is surrounded by a wall extending through the void chamber and surrounding an opening of the lower plate so as to form a plurality of channels being fluid-tightly separated from the hollow space being defined in the void chamber between the channels, wherein the hollow space is connected with an inlet for heat medium and with an outlet for heat medium.

This solution bases on the finding that such a heatable distributor comprising a hollow double-plate assembly comprising an upper plate and a lower plate being arranged on top of each other, but spaced apart so that a void chamber is defined therebetween, wherein each of both plates comprises a plurality of openings, wherein each opening of the upper plate is surrounded by a wall extending through the void chamber and surrounding an opening of the lower plate so as to form a plurality of channels fluidly connecting the upper and the lower plates so as to allow falling strands-which are generated from the composition flowing from the upper plate through the channels downwardly-to fall from the lower side of the lower plate downwardly, wherein the channels are fluid-tightly separated from the hollow space being defined in the void chamber between the channels, wherein the hollow space is connected with an inlet for heat medium and with an outlet for heat medium, allows to reliably control the devolatilization operating temperature during the operation of a devolatilization apparatus comprising such a distributor. More specifically, the composition to be devolatilized, such as a composition containing a temperature-sensitive polymer, enters through the heatable distributors comprising a hollow double-plate assembly being precisely temperature controllable and falls onto one or more preferably heatable tray(s) comprising a hollow double-plate assembly being precisely temperature controllable on account of the hollow space of the void chamber through which heat medium being adjusted to an appropriate and optimal temperature flows, so that not only the upper plate is precisely temperature controlled by the heat medium flowing below the lower side of the upper plate through the hollow space and not only the lower plate is precisely temperature controlled by the heat medium flowing above the upper side of the lower plate, but also and in particular all the channels, through which the composition to be devolatilized flows downwardly through the hollow double-plate assembly, are precisely temperature controlled. Thus, already in the distributor a high amount of the volatile component(s) is evaporated from the composition to be devolatilized, before the composition to be devolatilized falls downwards onto one or more heated tray(s), where it is precisely heated while being held up on the tray, then flows through the channels of the tray and forms at the lower side of the lower plate falling strands falling downwardly onto the next lower tray. Thereby, volatile component(s) efficiently sperate from the polymer of the composition to be devolatilized. Since the distributor and each of the tray(s) can be individually and precisely temperature controlled by appropriately adjusting the temperature of the heat medium transported through the hollow space of the void chamber of the respective distributor or tray, the devolatilization apparatus in accordance with the present disclosure allows to reliably control the devolatilization operating temperature during the operation of the devolatilization apparatus and in particular to individually and reliably control the devolatilization operating temperature in different sections of the devolatilization apparatus. This allows not only to devolatilize a composition containing a temperature-sensitive polymer, but also to devolatilize a composition containing a mixture of thermally sensitive volatile components and of non-thermally sensitive volatile components. For instance, the hollow double-plate assembly of the distributor installed in the upper section of the vessel can be adjusted to a comparable low temperature so as to remove thermal sensitive volatile components, whereas the hollow double-plate assemblies of the trays installed in the lower section of the vessel can be adjusted to a comparable high temperature so as to remove thermally non-sensitive volatile components. Furthermore, the devolatilization apparatus in accordance with the present disclosure allows to compensate the heat loss and temperature drop inside the vessel, which is caused by the evaporation of volatile components. Consequently, the distributor in accordance with the present disclosure allows if installed in a devolatilization apparatus to achieve an optimal devolatilization of the composition to be devolatilized at low operational costs, wherein the distributor as well as the devolatilization apparatus is characterized by low capital expenditures, so that a devolatilized composition with an optimal product quality is obtained even in a case that the composition to be devolatilized is a polymer composition comprising a particular temperature sensitive polymer.

According to the present disclosure, the heatable distributor comprises at least one vessel. The at least one vessel is preferably an at least substantial horizontal vessel, meaning that, if installed in the devolatilization apparatus, its longitudinal axis extends at least substantial horizontal. At least substantially horizontal means in this connection that the angle between the longitudinal axis of the vessel and the horizontal direction is at most 20°, preferably at most 1°, more preferably at most 5°, still more preferably at most 1° and most preferably 0°.

Preferably, the peripheral area and the first lateral end of the upstream portion of the vessel of the heatable distributor are, except for the inlet, completely bordered by a wall, i.e. the upstream portion of the vessel of the heatable distributor is, except for the area of the second lateral end of the upstream portion, closed by one or more walls.

The present disclosure is not particularly restricted concerning the cross-sectional form of the upstream portion of the vessel. For instance, the upstream portion of the vessel can have a circular, elliptic, oval, rectangular, square or polygonal cross-section. Good results are in particular achieved, when the upstream portion of the vessel has a circular, elliptic or oval cross-section.

In a further development of the idea of the present disclosure, the first lateral end of the downstream portion of the vessel has the same form and dimensions as the second lateral end of the upstream portion of the vessel.

In accordance with one preferred variant of the present disclosure, the peripheral area of the downstream portion of the vessel is partially bordered by a wall and the remainder of the peripheral area is bordered by one or more hollow double-plate assemblies, wherein the second lateral end of the downstream portion of the vessel is bordered by a wall or is open. The present disclosure is also not particularly restricted concerning the cross-sectional form of the downstream portion of the vessel. For instance, the downstream portion of the vessel can have a circular, elliptic, oval, rectangular, square or polygonal cross-sectional form. Good results are in particular achieved, when the downstream portion of the vessel has a circular, elliptic or oval cross-section. Still more preferably, both, the upstream as well as the downstream portion of the vessel have the same dimension and cross-sectional form, which is particularly preferred circular, elliptic or oval. In this embodiment, the complete peripheral area of the vessel of the heatable distributor is closed, namely the peripheral area of the upstream portion is bordered by one or more walls and the peripheral area of the downstream portion is bordered by one or more hollow double-plate assemblies and one or more walls. While the first lateral end of the upstream portion of the vessel is, except for the inlet, closed, the second lateral end of the downstream portion of the vessel can be open or closed by a wall.

In accordance with an alternative, preferred variant of the present disclosure, the peripheral area of the downstream portion of the vessel of the heatable distributor is completely bordered by a wall and the second lateral end of the downstream portion of the vessel is slanted and at least partially bordered by one or more hollow double-plate assemblies. Also in this embodiment, the downstream portion of the vessel can have a circular, elliptic, oval, rectangular, square or polygonal cross-sectional form. Good results are in particular achieved, when the downstream portion of the vessel has a circular, elliptic or oval cross-section. Still more preferably, both, the upstream as well as the downstream portion of the vessel have the same dimension and cross-sectional form, which is particularly preferred circular, elliptic or oval. In this embodiment, the complete peripheral area of the vessel of the heatable distributor is closed, namely the peripheral area of the upstream portion is bordered by one or more walls and the peripheral area of the downstream portion is bordered by one or more walls. While the first lateral end of the upstream portion of the vessel is, except for the inlet, closed, the second lateral end of the downstream portion of the vessel can be open or closed by a wall, the slanted second lateral end of the downstream portion of the vessel is at least partially bordered by one or more hollow double-plate assemblies.

Good results re in particular obtained, when the inclination angle of the second lateral end of the downstream portion of the vessel of the heatable distributor with regard to the horizontal direction is more than 0° to 90°, more preferably 5° to 60°, still more preferably 10° to 70° and most preferably 20 to 40°.

The area of the slanted of the second lateral end of the downstream portion of the vessel can by completely bordered by one or more hollow double-plate assemblies. However, in order to avoid an overpressure during the heatable distributor in the vessel, it is preferred that the second lateral end of the downstream portion of the vessel is partially bordered by one or more hollow double-plate assemblies. It is in particular preferred that at least 50%, more preferably at least 60%, still more preferably 60 to 95% and most preferably 70 to 90% of the area of the second lateral end of the downstream portion of the vessel is bordered by one or more hollow double-plate assemblies, whereas the remaining area is open, thereby allowing a pressure equalization.

Good results are in particular obtained, when the second lateral end of the downstream portion of the vessel is at least partially bordered by one to ten, preferably one to five, more preferably two to five and most preferably three hollow double-plate assemblies, which are arranged side by side and are connected with each other.

In accordance with the present disclosure, the plurality of channels of the hollow double-plate assembly of the heatable distributor is fluid-tightly separated from the hollow space being defined in the void chamber between the channels. Thereby, it is meant in accordance with the present disclosure that fluid, i.e. composition to be devolatilized, flowing through the channels from the upper to the lower plate cannot enter the hollow space, in which the heat medium flows, and that heat medium flowing in the hollow space cannot enter the channels. Plurality of channels means in this connection two or more, preferably five or more and more preferably ten or more channels.

In accordance with the present disclosure, the hollow double-plate assembly of the heatable distributor comprises an upper plate and a lower plate being arranged on top of each other. This means that in addition to the upper plate and the lower plate, baffles and/or weirs and/or side walls can be arranged within or at the hollow double-plate assembly. Theoretically, the hollow double-plate assembly can comprise one or more further plates in addition to the upper or lower plate, but preferably the hollow double-plate assembly does not contain any further plate in addition to the upper or lower plate.

The present disclosure is not particularly restricted concerning the relative orientation of the upper plate and the lower plate of the hollow double-plate assembly of the heatable distributor. Preferably, the upper plate and the lower plate are arranged at least substantially parallel to each other. At least substantially parallel to each other means in accordance with the present disclosure that the upper plate and the lower plate are not inclined in relation to each other by more than 10°, preferably by not more than 5°, more preferably by not more than 2° and still more preferably by not more than 1°. Most preferably, the upper plate and the lower plate are arranged parallel to each other, i.e. they are not inclined in relation to each other.

In a further development of the idea of the present disclosure, it is proposed that the upper plate and the lower plate are connected with each other at their sides through sidewalls, between which the void chamber is defined. Thereby, in an easy manner the void chamber of the hollow double-plate assembly can be fluid-tightly separated from the surroundings.

Concerning the form of the upper plate and of the lower plate, the present disclosure is not particularly limited. For instance, the upper plate as well as the lower plate can have, seen in top view, a polygonal, a rectangular, a square, a circular, an oval or a trapezoidal form. However, it is preferred that the upper plate and the lower plate both have the same form. Most preferably, the upper plate as well as the lower plate have, seen in top view, a rectangular form or at least substantially a rectangular form.

Also concerning the material of the upper plate and of the lower plate no particular restrictions exist, as long as the material has a comparable good heat conductivity and as long as it is resistant to the composition to be devolatilized and mechanically stable. Good results are in particular obtained, when each the upper plate and of the lower plate is made from stainless steel, carbon steel or the like.

The preferred thickness of the upper plate and of the lower plate depend on the mechanical stability of the material, from which the upper plate and the lower plate are made, wherein the thickness is preferably as low as possible so as to have a fast and efficient heat conduction from the heat medium flowing through the hollow space of the void chamber through the plate. In view of this, it is preferred that the upper plate and the lower plate each have a thickness of 1 to 10 mm and preferably of 3.5 to 6 mm.

In accordance with the present disclosure, each of the openings of the upper plate is surrounded-at its lower side-by a wall extending through the void chamber and surrounding an opening of the lower plate-at its upper side-so as to form a plurality of channels so that each of the channels fluidly connects an opening of the upper plate with an opening of the lower plate, thus allowing composition to be devolatilized to flow form the upper plate through the channels to the lower plate and fall from there in form of falling strands downwardly. In view of this, it is preferred that the upper plate and the lower plate have the same number of openings.

In a further development of the idea of the present disclosure, it is suggested that the total area of all openings of the upper plate is 0.1 to 40% and preferably 1 to 10% of the total surface area of the upper plate and that the total area of all openings of the lower plate is 0.1 to 40% and preferably 1 to 10% of the total surface area of the lower plate. Thereby, on the one hand enough non-perforated surface is present on the upper side of the upper plate so as to precisely heat the composition to be devolatilized to the desired optimal temperature and on the other hand enough opening area is present so that a sufficient amount of the composition can flow through the channels downwardly and leave the hollow double-plate assembly as falling strands.

The present disclosure is not particularly restricted concerning the form of the channels. They may or may not have the same form as the openings and they may or may not have a constant cross-sectional area over their length, i.e. seen in the vertical direction. However, good results are in particular obtained, when the channels have at least substantially same form as the openings and when they have an at least substantially constant cross-sectional area over their length.

Likewise to this, the present disclosure is not particularly limited concerning the cross-sectional form of the openings. For instance, some or preferably all of the openings of the upper plate and of the lower plate can have a polygonal, a rectangular, a square, a circular, an oval or a trapezoidal cross-sectional form. More preferably, at least some and most preferably all of the openings of the upper plate and of the lower plate have a circular cross-sectional form. In view of this, it is preferred that the openings of the upper plate and of the lower plate have a circular cross-sectional form, wherein at least 50%, preferably at least 80%, more preferably at least 95% and most preferably all of the openings of the upper plate and of the lower plate have at least substantially the same diameter. At least substantially the same diameter means in this connection that any of the openings has a diameter differing by not more than 20%, preferably by not more than 10%, more preferably by not more than 5% and most preferably by not more than 1% from the average diameter of all openings. Most preferably all openings have the same diameter. The average diameter of all openings is the sum of the diameters of all openings of the upper and lower plates divided by the total number of all openings of the upper and lower plates. In other words, it is most preferred that the channels have a cylindrical form with, seen in their length direction, an at least substantially constant diameter and most preferably a constant diameter. In this case the diameter of an opening of the upper plate has the same diameter than the respective opening of the lower plate, which is connected with the opening of the upper plate via the wall. However, if the openings have a different form than a circular cross-sectional form, such as a rectangular cross-sectional form, then preferably at least 50%, preferably at least 80%, more preferably at least 95% and most preferably all of the openings of the upper plate and of the lower plate have at least substantially the same cross-sectional area, wherein at least substantially the same cross-sectional area means that any of the openings has a cross-sectional area differing by not more than 20%, preferably by not more than 10%, more preferably by not more than 5% and most preferably by not more than 1% from the average cross-sectional area of all openings.

In accordance with a further preferred embodiment of the present disclosure, the average longest dimension of the openings 5 to 50 mm or 20 to 80 mm or 50 to 150 mm. Longest dimension of an opening means the longest possible line connecting a point of the circumferential line of the opening with a point being located on the circumferential line on the opposite side of the opening. More preferably, the openings of the upper plate and of the lower plate have a circular cross-sectional form, wherein the average diameter of the openings is 5 to 50 mm or 20 to 80 mm or 50 to 150 mm. The preferred diameter depends on the viscosity of the composition to be devolatilized and flowing through the openings. For instance, an average longest dimension or average diameter, respectively, of the openings of 5 to 50 mm is preferred, if the viscosity of composition to be devolatilized is 10 to 1,000 Pa.s, whereas an average longest dimension or average diameter, respectively, of the openings of 20 to 80 mm is preferred, if the viscosity of composition to be devolatilized is more than 1,000 to less than 5,000 Pa.s, and an average longest dimension or average diameter, respectively, of the openings of 50 to 150 mm is preferred, if the viscosity of composition to be devolatilized is 5,000 to 10,000 Pa.s.

The function of the hollow space of the void chamber of the hollow double-plate assembly is to precisely and homogeneously temperate the composition to be devolatilized flowing over the upper plate and through the channels from the upper to the lower plate by the heat medium, which is introduced into the hollow space of the void chamber through the inlet for heat medium, pressed through the hollow space and is withdrawn from the hollow space through the outlet for heat medium. In order to have a sufficient volume for the heat medium to precisely and homogeneously temperate the upper plate, the lower plate and the walls of the channels and to thereby precisely and homogeneously temperate by the heat medium the composition to be devolatilized flowing over the upper plate and through the channels from the upper to the lower plate, it is preferred that the height of the hollow space of the void chamber is 2 to 50 mm, more preferably 2 to 20 mm, still more preferably 4 to 12 mm and most preferably between 6 and 8 mm. The height of the hollow space is the distance between the lower side of the upper plate and the upper side of the lower plate. If the upper plate and the lower plate are not parallel to each other, the height of the hollow space is the average distance between the lower side of the upper plate and the upper side of the lower plate, wherein the average distance is the sum of the distances of heights of adjacent vertical sections of the hollow space divided by the number of adjacent vertical sections.

The present disclosure is not particularly restricted concerning the form of the inlet for heat medium and of the outlet for heat medium being connected with the hollow space of the void chamber of the hollow double-plate assembly. For instance, each of the inlet as well as of the outlet is a line and preferably a pipe, which extends through an opening of a sidewall surrounding the void chamber into the hollow space. Both, the inlet as well as of the outlet can be arranged on one side of the hollow double-plate assembly or on opposite sides of the hollow double-plate assembly. Alternatively, each of the inlet as well as of the outlet is a line and preferably a pipe, which extends through an opening of the upper plate or of the lower plate into the hollow space. Still alternatively, one of the inlet and of the outlet is a line and preferably a pipe, which extends through an opening of a sidewall surrounding the void chamber into the hollow space, whereas the other of the inlet and of the outlet is a line and preferably a pipe, which extends through an opening of the upper plate or of the lower plate into the hollow space.

In order to achieve a homogenous distribution of the heating medium in the hollow space of the void chamber, it is preferred that one or more, more preferably one to ten and still more preferably two to five at least substantially vertically arranged baffles are arranged in the hollow space of the void chamber and extend over a part of the hollow space so as to guide the heat medium in the hollow space of the void chamber. At least substantially vertically means in this connection that the angle between the baffle and the vertical direction is at most 10°, preferably at most 5°, more preferably at most 1° and most preferably 0°. Good results are in particular obtained, when the baffles are preferably arranged at least substantially perpendicular to the length axis of the hollow double-plate assembly. At least substantially perpendicular means in this connection that the angle between a baffle and the length direction of the hollow double-plate assembly is 80 to 100°, preferably 85 to 95°, more preferably at most 89 to 91° and most preferably 90°. In a preferred embodiment, at least some of the neighboring baffles are each extended from the opposite sidewalls of the void chamber in a direction being substantially perpendicular to the length axis of the hollow double-plate assembly. In a further preferred embodiment, all of the neighboring baffles are each extended from the opposite sidewalls of the void chamber in a direction being substantially perpendicular to the length axis of the hollow double-plate assembly.

It is not practical that the size of a hollow double-plate assembly is comparable large, but then to use more than one hollow double-plate assembly in the heatable distributor. In view of this, the downstream portion of the vessel of the heatable distributor comprises preferably 1 to 10, more preferably 2 to 5 and most preferably 2 to 4, such as 3, of the aforementioned hollow double-plate assemblies. If the heatable distributor comprises more than one hollow double-plate assembly, the two or more hollow double-plate assemblies are preferably arranged side by side. For instance, adjacent double-plate assemblies are connected with each other by welding or one or more fasteners. In order to achieve a homogenous distribution of the composition to be devolatilized on the surface of the heatable distributor, it is possible to arrange an at least substantially vertically extending perforated weir between two adjacent double-plate assemblies, wherein the perforated weir can extend over the whole length or width of the heatable distributor so as to allow composition to flow from one hollow double-plate assembly to the adjacent hollow double-plate assembly only via the openings of the perforated weir. For instance, the perforated weir has a height of 20 to 50 mm and preferably of 30 to 40 mm. The perforated weir can also comprise one or more holes allowing one or more fasteners to connect adjacent double-plate assemblies with each other.

Good results are in particular obtained, when the total area of all openings of the perforated weir is 1 to 30% and preferably 10 to 20% of the total surface area of the perforated weir. It is further preferred that the openings of a perforated weir has a circular cross-sectional form, wherein at least 50%, preferably at least 80%, more preferably at least 95% and most preferably all of the openings of the perforated weir have at least substantially the same diameter, wherein at least substantially the same diameter means that the openings have a diameter differing by not more than 20%, preferably by not more than 10%, more preferably by not more than 5% and most preferably by not more than 1% from the average diameter of all openings. For instance, the openings of a perforated weir have a circular cross-sectional form and a diameter of 5 to 30 mm and preferably of 10 to 20 mm.

In accordance with a further aspect, the present disclosure relates to a devolatilization apparatus for devolatilizing a composition comprising a volatile component, such as for devolatilizing a solid or liquid polymer composition comprising non-reacted monomer, solvent and/or by-product, wherein the devolatilization apparatus comprises a container comprising at least one inlet for the composition to be devolatilized, at least one outlet for devolatilized composition, at least one outlet for gas, and at least one aforementioned heatable distributor. The devolatilization apparatus preferably further comprises at least one heatable tray.

The at least one aforementioned heatable distributor is preferably arranged in the devolatilization apparatus so that the vessel of the heatable distributor extends at least substantially horizontal.

Container means in principle the same as vessel, but for the ease of differentiation vessel is used herein for the distributor and container for the devolatilization apparatus.

The distributor can be flanged to the devolatilization apparatus in order to ease the installation and maintenance.

In accordance with a further particularly preferred embodiment of the present disclosure, the devolatilization apparatus comprises one aforementioned heatable distributor and 1 to 20, preferably 5 to 15 and more preferably 7 to 12 heatable trays. It is preferred that each of the heatable trays comprises, seen in the horizontal plane, over all of its area one or more of the aforementioned hollow double-plate assemblies.

According to still a further preferred embodiment of the present disclosure, the devolatilization apparatus comprises a cartridge or frame, respectively, which comprises support elements, on which at least one heatable distributor and/or at least one heatable tray are removably or fixedly arranged. For instance, the cartridge can comprise several at least substantially horizontally arranged beams being arranged spaced apart from each other so as to border an inner space, such as preferably a hollow cylindrical inner space. At least substantially horizontally means in this connection that the angle between a beam and the horizontal direction is at most 10°, preferably at most 5°, more preferably at most 1° and most preferably 0°. It is further preferred that support elements are fixed on the beams so that the heatable trays can be placed on the support elements. Preferably, the support elements are annular support elements. The cartridge can further comprise one central inlet line for heating medium and one central outlet line for heating medium, wherein the inlet line for heating medium is connectable to the inlets of the heatable tray(s) and distributor(s) and the outlet line for heating medium is connectable to the outlet of the at least one heatable distributor and the at least one heatable tray. Thus, all heatable trays share in the cartridge one common inlet and outlet for heat medium so that preferably all of the heatable trays are connected to one heat medium circulating pipe.

Also in the case that the devolatilization apparatus does not comprise a cartridge or frame, respectively, which comprises support elements, on which the heatable distributor and heatable trays are removably or fixedly arranged, it is preferred that all heatable distributors and trays share one common inlet and outlet for heat medium so that preferably all of the heatable distributors and trays are connected to one heat medium circulating pipe.

Preferably, the devolatilization apparatus is embodied as static devolatilization apparatus, i.e. it does not comprise moving parts.

In addition, the devolatilization apparatus can comprise a pump for generating a sub-atmospheric pressure inside the container during the operation of the devolatilization apparatus.

In a further development of the idea of the present disclosure, it is suggested that the container comprises a central inlet for heating medium as well as a central outlet for heating medium, wherein the inlets for heating medium of the heatable tray(s) and of the distributor(s) are connected via lines with the central inlet for heating medium, and wherein the outlets for heating medium of the heatable tray(s) and of the distributor(s) are connected via lines with the central outlet for heating medium.

In a further aspect, the present disclosure relates to a method for devolatilizing a composition comprising a volatile component comprising the steps of feeding the composition into the inlet of the aforementioned devolatilization apparatus, of feeding heating medium into the at least one heatable distributor, of withdrawing gas from the outlet for gas and of withdrawing devolatilized composition from the outlet for devolatilized composition.

Preferably, a polymer composition containing monomer(s) and solvent is used as composition to be devolatilized.

For instance, the composition to be devolatilized has a viscosity of 1 to 10,000 Pa.s measured at the devolatilization operational temperature which is defined by the physical properties of different feeding polymer solution, using a rheometer of the plate-plate or of the cone-plate or cylinder type).

The pressure and temperature adjusted during the method within the container depends on the specific composition, which is devolatilized. For instance, the pressure within the container can be adjusted to 0.1 to 1,500 kPa and preferably 0.1 to 200 kPa, such as 0.5 kPa, 1 kPa, 3 kPa, 5 kPa, 10 kPa, 20 kPa, 50 kPa, 80 kPa, 100 kPa, 200 kPa, 500 kPa, 800 kPa, 1000 kPa or 1300 kPa, and the heating medium in each of the hollow spaces of the hollow double-plate assembly can be adjusted to 40 to 300° C. and preferably 70 to 250° C., such as 50° C., 60° C., 70° C., 80° C., 100° C., 130° C., 150° C., 170° C., 190° C., 210° C., 230° C., 250° C., 270° C. or 290° C.

Suitable examples for polymer compositions to be devolatilized are compositions based on polyacrylonitrile, polylactic acid, polyolefin, polyolefin elastomer and/or synthetic rubber.

In a further development of the idea of the present disclosure, it is suggested that in the method a composition is devolatilized, which is a mixture containing i) at least one heat sensitive polymer and/or heat sensitive monomer and ii) at least one heat non-sensitive polymer and/or heat non-sensitive monomer. It is preferred in this embodiment that the method is performed in a devolatilization apparatus comprising in the upper section of the container at least one distributor and at least one and preferably at least two trays each of which comprising a hollow double-plate assembly and in the lower section of the container at least one and preferably at least two trays each of which comprising a hollow double-plate assembly, wherein the hollow double-plate assemblies of the distributor and trays installed in the upper section of the container are adjusted to a comparable low temperature so as to remove there the heat sensitive component(s), whereas the hollow double-plate assemblies of the trays installed in the lower section of the vessel are adjusted to a higher temperature so as to remove there the heat non-sensitive component(s).

The method in accordance with the present disclosure allows to reduce the content of non-polymeric compounds in the polymer composition to less than 600,000 ppm, preferably to less than 200,000 ppm, more preferably to less than 100 ppm and most preferably to less than 10 ppm.

### BRIEF DESCRIPTION OF THE DRAWINGS

Subsequently, the present patent application is described by way of example with reference to advantageous embodiments and to the enclosed drawings.

There is shown:

FIGS. 1A and 1B show a schematic longitudinal-sectional view (FIG. 1A) and a schematic top view of the second lateral end (FIG. 1B) of a heatable distributor according to the present disclosure.

FIG. 2 shows a schematic longitudinal-sectional view of a devolatilization apparatus according to one embodiment of the present disclosure.

FIG. 3 shows a perspective view of a heatable tray of the devolatilization apparatus shown in FIG. 2.

FIG. 4 shows a cross-sectional view of a hollow double-plate assembly of the heatable tray shown in FIG. 3.

FIG. 5 shows a schematic view of a cartridge for holding heatable trays, which can be included in a devolatilization apparatus according to the present disclosure.

### DETAILED DESCRIPTION

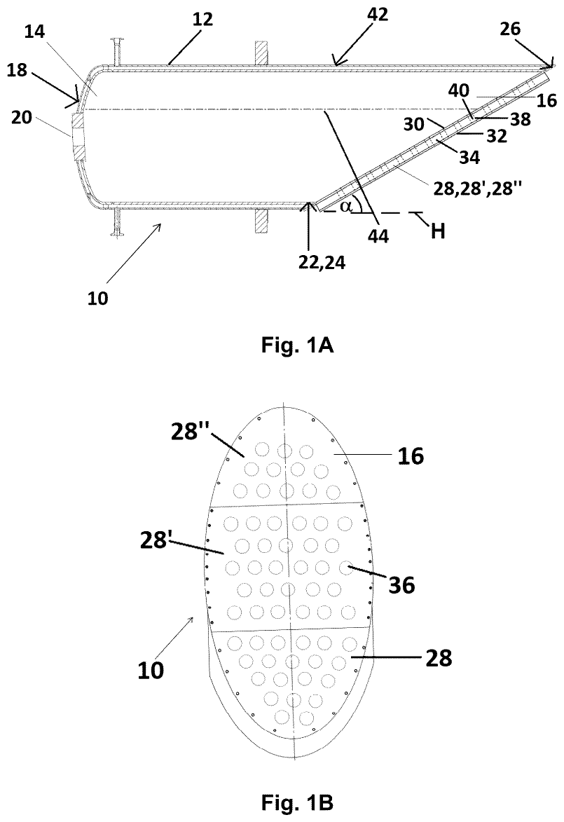

FIGS. 1A and 1B show a heatable distributor 10 in accordance with the present disclosure. The heatable distributor 10 comprises a horizontal vessel 12 with an upstream portion 14 and an adjacent downstream portion 16, wherein the upstream portion 14 of the vessel 12 comprises a first lateral end 18 comprising an inlet 20 and an opposite second lateral end 22. The second lateral end 22 of the upstream portion 14 of the vessel 12 is connected with the downstream portion 16 of the vessel 12, wherein the downstream portion 16 of the vessel 12 comprises a first lateral end 24 and an opposite second lateral end 26 with the first lateral end 24 being connected with the second lateral end 22 of the upstream portion 14. More specifically, the second lateral end 26 of the downstream portion 16 of the vessel 12 is slanted with an inclination angle a with regard to the horizontal direction H of about 45°. Moreover, the second lateral end 26 of the downstream portion 16 of the vessel 12 is partially bordered by three hollow double-plate assemblies 28, 28′, 28″. As shown in FIG. 1B, the three hollow double-plate assemblies 28, 28′, 28′ are arranged side by side and are connected with each other. Each of the hollow double-plate assemblies comprises an upper plate 30 and a lower plate 32 being arranged on top of each other, but spaced apart so that a void chamber 34 is defined therebetween. Each of both plates 30, 32 comprises a plurality of openings 36, wherein each opening of the upper plate 30 is surrounded by a wall 38 extending through the void chamber 34 and surrounding an opening of the lower plate 32 so as to form a plurality of channels 40 being fluid-tightly separated from the void chamber 34. The void chamber 34 is connected with an inlet for heat medium (not shown) and with an outlet for heat medium (not shown). All of the peripheral area 42 of the upstream portion 14 and of the downstream portion 16 and of the first lateral end 18 of the upstream portion 14 of the vessel 16 are, except for the inlet 20, completely bordered by a wall. During the operation of the distributor 10, the composition to be devolatilized is fed via the inlet 20 into the interior of the upstream portion 14 of the vessel 20 and flows through the upstream portion 14 and downstream portion 16 of the vessel 12 to the second lateral end 26 of the downstream portion 16 of the vessel 12 through the channels 40 of the three hollow double-plate assemblies 28, 28′, 28″, where the composition is precisely adjusted to a predetermined temperature, before the composition then exits the channels 40 of the three hollow double-plate assemblies 28, 28′, 28″ and fall down. During the operation, the liquid level can reach the broken line 44.

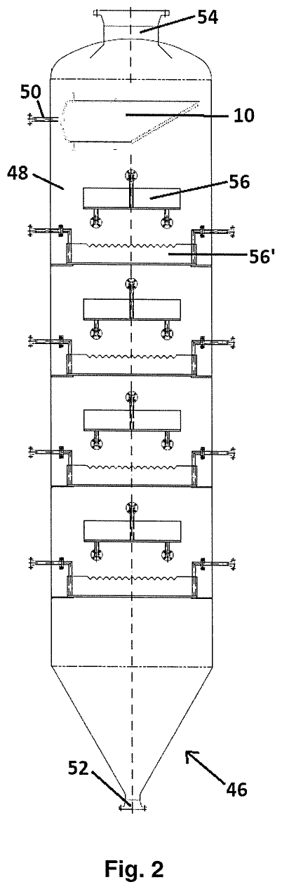

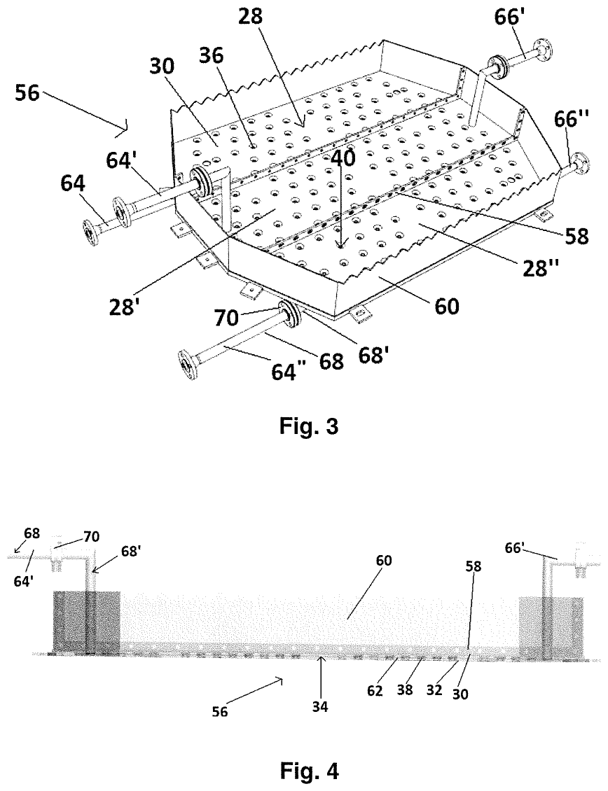

The devolatilization apparatus 46 for devolatilizing a composition comprising a volatile component, such as for devolatilizing a solid or liquid polymer composition comprising non-reacted monomer and solvent, shown in FIG. 2 comprises a container 48 comprising an inlet line 50 for the composition to be devolatilized, an outlet line 52 for devolatilized composition, an outlet line 54 for gas, a heatable distributor 10 embodied as shown in FIG. 1a and 1b and eight heatable trays 56, 56′ being arranged on top of each other, wherein adjacent trays 56, 56′ are rotated by 90°. As shown in more detail in FIGS. 3 and 4, each of the heatable trays 56, 56′ comprises three hollow double-plate assemblies 28, 28′, 28″, which are arranged side by side, wherein adjacent hollow double-plate assemblies 28, 28′, 28″ are welded to each other and between two adjacent hollow double-plate assemblies 28, 28′, 28″ an at least substantially vertically arranged perforated weir 58 is arranged. At its outer circumference, the trays 56, 56′ are surrounded each by a vertically arranged non-perforated weir 60. Each of the hollow double-plate assemblies 28, 28′, 28″ comprises an upper plate 30, a lower plate 32 being arranged on top of each other, but spaced apart so that a void chamber 34 is defined therebetween. Each of the upper plate 30 and the lower plate 32 comprises a plurality of openings 36, wherein each opening 36 of the upper plate 30 is surrounded by a wall 38 extending through the void chamber 34 and surrounding an opening of the lower plate so as to form a plurality of channels 40 being fluid-tightly separated from the hollow space 62 being defined in the void chamber 34 between the channels 40. Each of the hollow double-plate assemblies 28, 28′, 28″ comprises an inlet line 64, 64′, 64″ for heat medium as well as an outlet line 66, 66′, 66″ for heat medium (only two are shown in FIG. 3). While the inlet lines 64, 64″ for heat medium and the outlet lines 66″ for heat medium of the two outer hollow double-plate assemblies 28, 28″ enter the two outer hollow double-plate assemblies 28, 28″ from below, the inlet line 64′ for heat medium and the outlet line 66′ for heat medium of the middle hollow double-plate assembly 28′ enters the middle hollow double-plate assembly 28′ from above. Each inlet line 64, 64′, 64″ for heat medium as well as each outlet line 66′, 66″ for heat medium is in fact composed of two pipes 68, 68′, which are connected with each other by a flange 70 being arranged inside the container 48. The alternative arrangement of the inlet lines 64, 64′, 64″ for heat medium and of the outlet lines 66′, 66″ for heat medium facilitates the installation. During the installation, the container 48 will be laid down horizontally and the hollow double-plate assemblies 28, 28′, 28″ will be in a vertical position facing the installation worker. The installation worker will install the outermost hollow double-plate assemblies 28, 28″ and will connect pipe 68′ with pipe 68 of the outermost hollow double-plate assemblies 28, 28″ by tightening the flange 70, while the middle hollow double-plate assembly 28′is yet not installed so that there is space in the middle allowing the worker to reach the flange 70 from below. If the inlet line 64′ and the outlet line 66′ for heat medium would be also connected with the middle hollow double-plate assembly 28′ from below, the worker would not be able to connect the two pipes for the middle hollow double-plate assembly 28′, but the worker is able to connect the two pipes for the middle hollow double-plate assembly 28′ from above.

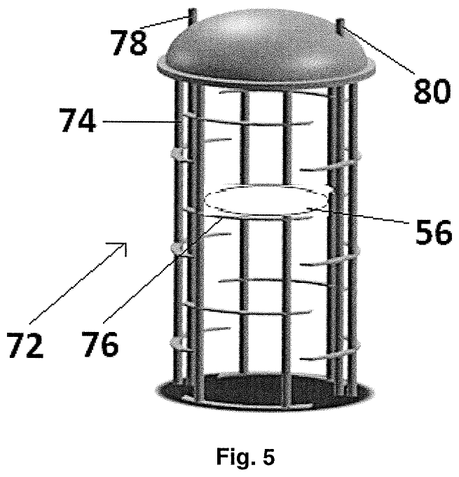

FIG. 5 shows a cartridge 72 for holding heatable trays, which can be included in a devolatilization apparatus according to the present disclosure. The cartridge 72 comprises several horizontally arranged beams 74 being arranged spaced apart from each other so as to border a hollow cylindrical inner space. Several annular support elements 76 are fixed at the beams 74 so that heatable trays 56 (only one tray is shown in FIG. 5) can be removably arranged on the support elements 76. Furthermore, the cartridge 72 comprises one central inlet line 78 for heating medium and one central outlet line 80 for heating medium, wherein the inlet line 80 for heating medium is connectable to the inlet lines of the heatable tray(s) 56 and the outlet line 80 for heating medium is connectable to the outlet lines of the heatable tray(s).

1. A heatable distributor for a devolatilization apparatus for devolatilizing a composition comprising a volatile component, the heatable distributor comprising:
at least one vessel with an upstream portion and an adjacent downstream portion, the upstream portion of the vessel comprises a first lateral end comprising an inlet and an opposite second lateral end being connected with the downstream portion, wherein the downstream portion of the vessel comprises a first lateral end and an opposite second lateral end with the first lateral end being connected with the second lateral end of the upstream portion, and the downstream portion of the vessel comprises a hollow double-plate assembly, the hollow double-plate assembly comprises an upper plate and a lower plate being arranged on top of each other, and spaced apart so that a void chamber is defined therebetween, each plate of the hollow double plate assembly comprising a plurality of openings, each opening of the plurality of openings of the upper plate is surrounded by a wall extending through the void chamber and surrounding an opening of the plurality of openings of the lower plate so as to form a plurality of channels being fluid-tightly separated from the hollow space being defined in the void chamber between the channels, the hollow space connected with an inlet for a heat medium and with an outlet for a heat medium, the at least one vessel is an at least substantial horizontal vessel, such that while installed in the devolatilization apparatus, its-a longitudinal axis of the at least one vessel extends at least substantial horizontal, such that the an angle between the longitudinal axis of the vessel and a horizontal direction is at most 20°, a peripheral area and the first lateral end of the upstream portion of the vessel are, except for the inlet, completely bordered by a wall, and the second lateral end of the downstream portion of the vessel is slanted with regard to the longitudinal axis.

2. (canceled)

3. The heatable distributor in accordance with claim 1, wherein the upstream portion of the vessel has a circular, elliptic, oval, rectangular, square or polygonal cross-section.

4. The heatable distributor in accordance with claim 1, wherein the first lateral end of the downstream portion of the vessel has a same form and dimensions as the second lateral end of the upstream portion of the vessel.

5. The heatable distributor in accordance with claim 1, wherein a peripheral area of the downstream portion of the vessel is partially bordered by a second wall and a remainder of the peripheral area is bordered by the hollow double-plate assembly, and the second lateral end of the downstream portion of the vessel is bordered by a third wall or is open.

6. The heatable distributor in accordance with claim 1, wherein a peripheral area of the downstream portion of the vessel is completely bordered by a second wall and the second lateral end of the downstream portion of the vessel is at least partially bordered by the hollow double-plate assembly.

7. The heatable distributor in accordance with claim 6, wherein an inclination angle of the second lateral end of the downstream portion of the vessel with regard to the horizontal direction is more than 0° to 90°.

8. The heatable distributor in accordance with claim 6, wherein at least 50% of an area of the second lateral end of the downstream portion of the vessel is bordered by the hollow double-plate assembly.

9. The heatable distributor in accordance with claim 6, wherein the hollow double-plate assembly is one of two to ten hollow plate assemblies, the second lateral end of the downstream portion of the vessel is at least partially bordered by the two to ten hollow double-plate assemblies, which are arranged side by side and are connected with each other.

10. The heatable distributor in accordance with claim 1, wherein the upper plate and the lower plate of the hollow double-plate assembly are arranged at least substantially parallel to each other, and, the upper plate and the lower plate are connected with each other at sides thereof through sidewalls, between which the void chamber is defined.

11. The heatable distributor in accordance with claim 1, wherein the upper plate and the lower plate of the hollow double-plate assembly have a same number of openings.

12. The heatable distributor in accordance with claim 1, wherein the plurality of openings of the upper plate and the plurality of openings of the lower plate of the hollow double-plate assembly have a circular cross-sectional form, -at least 50% of all of the plurality of openings of the upper plate and of the lower plate have at least substantially a same diameter, such that any one of the plurality of openings has a diameter differing by not more than 20% from an average diameter of all of the plurality of openings.

13. The heatable distributor in accordance with claim 1, wherein a height of the hollow space of the void chamber of the hollow double-plate assembly is 2 to 50 mm.

14. The heatable distributor in accordance with claim 1, wherein the upper plate and the lower plate of the hollow double-plate assembly are connected with each other at sides thereof through sidewalls, between which the void chamber is defined, and the inlet for the heat medium and the outlet for the heat medium are pipes extending through one or two of the sidewalls.

15. A devolatilization apparatus for devolatilizing a composition comprising:
a volatile component comprising a container comprising at least one inlet for the composition to be devolatilized, at least one outlet for devolatilized composition, at least one outlet for gas, at least one heatable distributor in accordance with claim 1.

16. The devolatilization apparatus in accordance with claim 14, wherein the at least one heatable distributor includes one heatable distributor and 1 to 20 heatable trays, each of the 1 to 20 heatable trays comprises, seen in the horizontal plane, over all of an area thereof the hollow double-plate assembly.

17. The devolatilization apparatus in accordance with claim further comprising a cartridge comprising support elements, on which the at least one heatable distributor or the at least one heatable tray are removably or fixedly arranged, the cartridge comprising a plurality of substantially horizontally arranged beams arranged spaced apart from each other so as to border an inner space, the support elements being fixed on the plurality of substantially horizontally arranged beams so that the at least one heatable distributor or the at least one heatable tray is capable of being placed on the support elements.

18. The devolatilization apparatus in accordance with claim 16, wherein the cartridge further comprises one central inlet line for a heating medium and one central outlet line for the heating medium, the inlet line for the heating medium is connectable to the heat medium and the outlet line for the heating medium is connectable to the outlet of the heat medium.

19. A method for devolatilizing the composition comprising the volatile component, the method comprising:
feeding the composition into the at least one inlet apparatus-in accordance with claim 14;
feeding the heating medium into the at least one heatable distributor;
withdrawing gas from the outlet for gas; and
withdrawing devolatilized composition from the outlet for devolatilized composition.

20. The method in accordance with claim 18, wherein the devolatilized composition is a mixture containing i) at least one heat sensitive polymer or heat sensitive monomer and ii) at least one heat non-sensitive polymer or heat non-sensitive monomer, the devolatilization apparatus comprising in an upper section of the vessel at least one a first tray comprising the hollow double-plate assembly and in a lower section of the vessel at least one second tray comprising another hollow double-plate assembly, the hollow double-plate assembly of the at least one first tray in the upper section of the vessel adjusted to a comparable low temperature so as to remove the at least one heat sensitive polymer or heat sensitive monomer, the another hollow double-plate assembly of the at least one second tray in the lower section of the vessel adjusted to a higher temperature so as to remove the at least one heat non-sensitive polymer or heat non-sensitive monomer.

21. The heatable distributor in accordance with claim 1, wherein the upper plate and the lower plate of the hollow double-plate assembly have a same number of openings, and a total area of all of the plurality of openings of the upper plate is 0.1 to 40% of a total surface area of the upper plate and a total area of all of the plurality of openings of the lower plate is 0.1 to 40% of a total surface area of the lower plate.
